(19) United States
(12) Patent Application Publication
(10) Pub. No.: US 2015/0047513 A1
(43) Pub. Date: Feb. 19, 2015

(54) TRAY FOR ELECTROMAGNETIC INDUCTION HEATING/COOKING AND ELECTROMAGNETIC INDUCTION HEATING DISH SET

(71) Applicant: F.T. Innovation Inc., Tokyo (JP)

(72) Inventors: Teruo Okano, Tokyo (JP); Manabu Izumi, Tokyo (JP)

(73) Assignee: F.T. Innovation Inc., Tokyo (JP)

(21) Appl. No.: 14/388,711

(22) PCT Filed: Mar. 26, 2013
(86) PCT No.: PCT/JP2013/058820

§ 371 Date: Sep. 26, 2014

(30) Foreign Application Priority Data
Mar. 26, 2012 (JP) 2012-069755

(51) Int. Cl. H05B 6/12

(52) U.S. Cl. CPC H05B 6/1209
USPC 99/358

(57) ABSTRACT

An electromagnetic induction heating and cooking tray being formed a recessed portion for accommodating an electromagnetic induction heating and cooking plate, is characterized in being provided with a tray main body being formed the recessed portion or a through hole configuring a portion of the recessed portion, a board-shaped, lineal, columnar and/or hollow-columnar first heat insulation member being molded and made of carbon fibers, aramid fibers and/or rock fiber, for supporting the plate; and feet being protruded from the bottom of the tray main body. Because the electromagnetic induction heating and cooking plate does not contact the tray main body as a result of being supported by the first heat insulation member and the heat of the plate is dissipated from the space formed by the feet, temperature increase of the tray and deterioration of the heat insulation member can be prevented even if the plate is heated. The tray can also be made lighter.

### CROSS-REFERENCE TO RELATED APPLICATIONS

This application claims priority to PCT Patent Application No. PCT/JP2013/058820 filed Mar. 26, 2013, which claims priority to Japanese Patent Application No. 2012-069755 filed Mar. 26, 2012.

### TECHNICAL FIELD

The present disclosure relates to an electromagnetic induction heating and cooking tray and an electromagnetic induction heating plate set including the tray and a plate.

### BACKGROUND ART

Traditionally, a cooking/heating plate for serving in which an iron plate is placed on a bottom board after heating, and cooking ingredients such as meat and the like is accommodated on the plate has been heavily used in the steakhouse and the like. For example, patent literature 1 describes a cooking/heating plate in which a heat insulation member and a heat storage member are placed on the groove of a bottom board, and a plate, on which cooking ingredients are placed on the upper part of the heat storage member heated by gas or the like, is placed. Patent literature 2 describes an electromagnetic induction heating plate set which includes a heating plate and the bottom board with the development of electromagnetic induction-heating cooking tools in recent years. A recessed portion is formed in the bottom board of the electromagnetic induction heating plate set so that lines of magnetic force reach the external surface of the heating plate bottom, and as electromagnetic induction heat can be applied to the heating plate on the bottom board, the electromagnetic induction heating plate can eliminate relocation by a dedicated tool and retain heat more efficiently.

Furthermore, patent literature 3 describes a food heating plate in which a heat storage member contacting the plate on which cooking ingredients are placed is fixed and engaged with a tray composed of nonmagnetic materials such as wood, so that the plate can be stably placed on the heat storage member over a long period of time. Patent literature 4 describes a food heating plate in which a through hole is formed in the heat storage member for reducing the weight thereof. Furthermore, patent literature 5 describes a food heating plate in which a through hole is formed in the tray and a heat storage member is fitted into the through hole such that the heat storage member can move in the vertical direction.

The heat storage members and plates of the food heating plates described in the above-mentioned patent literatures 2 to 5 are heated by electromagnetic induction. The food heating plates can be placed with the wooden trays on the heater of the electromagnetic induction heating and cooking-apparatus, and the cooking ingredients accommodated on the plate can be heated with the switch of the electromagnetic induction heating and cooking-apparatus turned on. As the plate can be moved to a table with the tray after the cooking is completed, the plate needs not be relocated and the food heating plates are superior in operability. Furthermore, they have an advantage of being superior in safety because no fire needs to be used.

### CITATION LIST

### Patent Literature

Patent Literature 1: Unexamined Japanese Utility Model Application Kokai Publication No. H07-27374

Patent Literature 2: Unexamined Japanese Utility Model Application Kokai Publication No. H05-51168

Patent Literature 3: Unexamined Japanese Patent Application Kokai Publication No. 2006-239298

Patent Literature 4: Unexamined Japanese Patent Application Kokai Publication No. 2007-20789

Patent Literature 5: Unexamined Japanese Patent Application Kokai Publication No. 2007-117101

### SUMMARY OF INVENTION

### Technical Problem

However, as the electromagnetic induction heating and cooking apparatus is excellent in heating efficiency, the heat from the heat storage member, or from the plate is transferred to wooden trays and the arranged heat insulation members are easily deteriorated. Thus, we cannot use the electromagnetic induction heating plate over a long period of time. Moreover, there are cases in which, due to deterioration of the heat insulation member, the heat from the heat storage member is transferred to the tray, and the tray becomes too hot for us to hold and handle the plate. There is a way to increase the volume of the heat insulation member to avoid the heat transfer to the tray. However, as the heat storage member needs to be placed in the magnetic field generated by the electromagnetic induction heating and cooking apparatus, the volume of the heat insulation member that can be arranged in the gap between the tray and the heat storage member is limited.

Moreover, if the thickness of the tray is increased for controlling the heat transfer from the heat storage member or from the plate to the tray, the weight of the tray together with the heat storage member or the plate is further increased and handling the tray become not easy.

Therefore, an objective of the present disclosure is to provide a durable and lightweight electromagnetic induction heating and cooking tray. Moreover, another objective of the present disclosure is to provide an electromagnetic induction heating plate set including the electromagnetic induction heating and cooking tray and an electromagnetic induction heating and cooking plate.

### Solution to Problem

The inventor reviewed an electromagnetic induction heating and cooking plate used in an electromagnetic induction heating and cooking apparatus and an electromagnetic induction heating and cooking tray for placing the plate (hereafter, simply referred to as a tray) in detail. As a result, the inventor found the following and completed the present disclosure: a temperature increase at the tray can be controlled by forming feet at the tray because the heat can be dissipated between the feet even if the electromagnetic induction heating and cooking plate is heated; and if a heat insulation member including a board-shaped, lineal, columnar and/or hollow-columnar heat insulation material, which carbon fibers, aramid fibers and/or rock fiber is molded, is fixedly installed in the tray and the plate is thereby supported, the heated plate can be accommodated without contacting the tray main body and thermal deterioration of the tray can be controlled.

That is, the present disclosure is to provide an electromagnetic induction heating and cooking tray being formed a recessed portion for accommodating an electromagnetic induction heating and cooking plate, which comprises:

a tray main body being formed the recessed portion or a through hole configuring a portion of the recessed portion,

a board-shaped, lineal, columnar and/or hollow-columnar first heat insulation member being molded and made of carbon fibers, aramid fibers and/or rock fiber, for supporting the plate; and

feet being protruded from the bottom of the tray main body.

Also, the present disclosure is to provide the above-mentioned electromagnetic induction heating and cooking tray, wherein one or more types of second heat insulation member selected from the group consisting of carbon fibers, aramid fibers and rock fibers, is arranged at the bottom of the recessed portion.

Also, the present disclosure is to provide the above-mentioned electromagnetic induction heating and cooking tray, wherein the tray main body is formed the through hole configuring a portion of the recessed portion, and wherein the second heat insulation member is attached to the through hole to form the bottom of the recessed portion.

Also, the present disclosure is to provide the above-mentioned electromagnetic induction heating and cooking tray, wherein temperature sensing means for detecting the temperature of the tray and/or alarm means that alarms when the temperature of the tray is equal to or more than a predetermined value is further arranged.

Also, the present disclosure is to provide an electromagnetic induction heating plate set including the above-mentioned electromagnetic induction heating and cooking tray and an heating and cooking plate heated by electromagnetic induction.

### Advantageous Effects of Invention

The present disclosure can provide a tray that can heat and cook ingredients by electromagnetic induction heating. Also, the present disclosure can provide an electromagnetic induction heating plate set with combinations of plates that can be heated by electromagnetic induction.

### BRIEF DESCRIPTION OF DRAWINGS

FIG. 1 is an explanatory drawing showing an electromagnetic induction heating plate set of the present disclosure, FIG. 1A is a fragmentary sectional view, and

FIG. 1B is a plan view of the tray configuring the electromagnetic induction heating plate set.

FIG. 2 is an explanatory drawing showing another aspect of the electromagnetic induction heating plate set of the present disclosure, FIG. 2A is a fragmentary sectional view, and FIG. 2B is a plan view of the tray configuring an electromagnetic induction heating plate set.

FIG. 3 is an explanatory drawing showing an aspect of the electromagnetic induction heating plate set of the present disclosure in which temperature sensing means, alarm means, and electromagnetic induction stop means are placed, and FIG. 3A is a sectional view, and FIG. 3B is a bottom view.

FIG. 4 is an explanatory drawing describing a method for manufacturing the tray of the present disclosure, FIG. 4A is a sectional view of the electromagnetic induction heating plate set including a plate, FIG. 4B is a sectional view of the plate, FIG. 4C is a sectional view of the tray top part having grips, FIG. 4D is a sectional view of the tray middle part laid across the first insulation member configuring the tray in a tensioned state, and FIG. 4E is a sectional view of the bottom of the tray bottom to which the second insulation member configuring the tray is adhered.

FIG. 5 is a drawing explaining the tray bottom to which the second insulation member shown in FIG. 4E configuring the tray is adhered; FIG. 5A shows a plan view of the tray bottom to which the second insulation member configuring the tray is adhered; FIG. 5B shows a plan view of the second insulation member and FIG. 5C shows a plan view of a tray bottom member.

FIG. 6 is a drawing explaining the tray middle part laid across the first insulation member shown in FIG. 4D configuring the tray in a tensioned state, FIG. 6A shows a plan view of the tray middle part laid across the first insulation member shown in FIG. 4D configuring the tray in a tensioned state, FIG. 6B shows a plan view of the first heat insulation member, and FIG. 6C shows a plan view of the tray middle member.

FIG. 7 is a drawing explaining the tray top part having the grip of the tray shown in FIG. 4C, FIG. 7A shows a sectional view of the tray top part, and FIG. 7B shows a plan view of tray top part.

FIG. 8 is a drawing explaining another aspect and a manufacturing method of the tray of the present disclosure, FIG. 8A is a plan view of the tray, FIG. 8B is a sectional view of the electromagnetic induction heating plate set including a plate, FIG. 8C is a sectional view and a side view of the first heat insulation member, FIG. 8D is a sectional view and a side view of the tray top part, and FIG. 8E is a sectional view and a side view of the tray bottom to which the second insulation member configuring the tray is adhered.

FIG. 9 is a drawing explaining another aspect and manufacturing method of the tray of the present disclosure, FIG. 9A is a plan view, FIG. 9B is a side view, FIG. 9C is a sectional view and a side view of the first heat insulation member arranged in the tray main body, FIG. 9D is a sectional view and a side view of the tray main body, and FIG. 9E is a sectional view and a side view of the second heat insulation member arranged in the tray main body.

### DESCRIPTION OF EMBODIMENTS

A first embodiment of the present disclosure is an electromagnetic induction heating and cooking tray being formed a recessed portion for accommodating an electromagnetic induction heating and cooking plate, which comprises:

a tray main body being formed the recessed portion or a through hole configuring a portion of the recessed portion,

a board-shaped, lineal, columnar and/or hollow-columnar first heat insulation member being molded and made of carbon fibers, aramid fibers and/or rock fiber, for supporting the plate; and

feet being protruded from the bottom of the tray main body. A second insulation member may be attached to the bottom of the recessed portion.

A second embodiment of the present disclosure is an electromagnetic induction heating plate set including the above-mentioned tray and an heating and cooking plate heated by electromagnetic induction. Hereinafter, the present disclosure is described in detail with the drawings.

(1) Electromagnetic Induction Heating Plate Set

The electromagnetic induction heating plate set of the present disclosure includes an electromagnetic induction heating and cooking plate, and a tray which can accommodate the plate. The tray includes a tray main body, in which a recessed portion or a through hole configuring a portion of the recessed portion is formed; and a board-shaped, lineal, columnar and/or hollow-columnar first heat insulation member, which is molded and made of carbon fibers, aramid fibers and/or rock fiber, for supporting the plate. Furthermore, the tray has feet, which protrude from the bottom of the tray main body. In addition, the plate is composed of a material to be heated by electromagnetic induction.

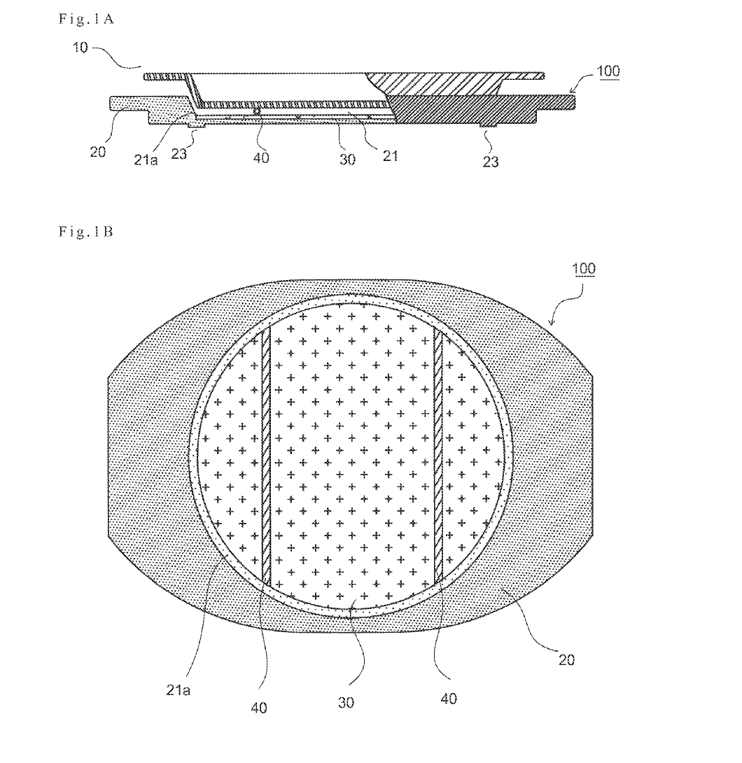

FIG. 1 is a drawing explaining an example of an embodiment of the electromagnetic induction heating plate set of the present disclosure, and FIG. 1A is a sectional view of the side portion. As shown in FIG. 1A, the electromagnetic induction heating plate set of the present disclosure includes an electromagnetic induction heating and cooking plate 10 and a tray 100, and a recessed portion 21 that can accommodate the plate 10 is formed in the approximate center of the tray 100. A board-shaped, lineal, columnar and/or hollow-columnar first heat insulation member, which is molded and made of carbon fibers, aramid fibers and/or rock fiber, for supporting the plate accommodated in the recessed portion 21 is fixedly installed to the tray main body 20. When the plate 10 is accommodated into the recessed portion 21 of the tray 20, as the plate 10 is supported by the first heat insulation member 40, the direct contact between the plate 10 and the tray main body 20 can be avoided. When the plate 10 is supported by the first heat insulation member 40, a gap, for example, between the recessed portion side wall 21a and the plate 10 can be formed, thereby inhibiting the heat transfer from the heated plate 10 to the tray 100.

The tray 100 of the present disclosure may be a tray in which one or more types of second heat insulation member 30, selected from the group consisting of carbon fibers, aramid fibers and rock fibers, is arranged at the bottom of the recessed portion 21. Such a tray can control the heat transfer from the heated plate 10 to the tray main body 20 and reduce the heat deterioration of the bottom of the tray 100.

The tray 100 of the present disclosure is characterized by forming the feet 23 protruded from the bottom of the tray main body 20. A gap is formed by the feet 23 between the heated face of the electromagnetic induction heating device and the bottom of the tray main body 20, the heat of the heated plate 10 is radiated from this gap, and excessive heating of the tray 100 can be inhibited.

As for an electromagnetic induction heating device, an electromagnetic induction heating plate, a pan or the like is generally placed in close contact with the heater of the electromagnetic induction heating device to increase the heating efficiency of electromagnetic induction. Even if the tray set of the present disclosure is placed on the electromagnetic induction heating device, the heater is not close contact with the plate 10 due to the feet 23, but the distance between the plate 10 and the heater is close enough to be heated by electromagnetic induction. The tray 100 of the present disclosure can maintain the heating efficiency of the plate 10 by the electromagnetic induction heating device, can control the heat transfer to the tray 100 and heat accumulation of the plate 10 by arranging the first heat insulation member 40, the second heat insulation member 30, and/or the feet 23, and thereby, can reduce the weight of the tray.

The first heat insulation member 40 is fixedly installed to the tray main body 20 to be able to support the plate 10. There is no particular limitation on supporting modes. For example, if the first heat insulation member 40 is fixedly installed to a position at the bottom of the plate 10, the plate 10 can be supported by the placement of the plate 10 on the upper part of the first heat insulation member 40. If the first heat insulation member 40 is fixedly installed such that the outer perimeter of the plate 10 can be laterally pressed, the plate 10 can be supported by the press. Additionally, if a flange is formed at the upper portion of the plate 10, when the first heat insulation member 40 is fixedly installed to a position at the lower part of the flange, the plate 10 can be hung and supported via the flange. FIG. 1 shows an embodiment in which two first heat insulation members 40 are laid across in a tensioned state at the bottom of the recessed portion 21. However, shapes, and positions and numbers to be fixedly installed of the first heat insulation members 40 are not limited to those shown in FIG. 1. If the plate 10 is supported by the first heat insulation member 40, space can be formed between the plate 10 and the recessed portion side wall 21a of the tray main body 20. Even when the plate 10 is heated, the space can prevent the heat from directly transferring to the recessed portion side wall 21a, and can prevent the heat deterioration of the recessed portion side wall 21a. In addition, FIG. 1 shows the embodiment in which the second heat insulation member 30 is further arranged at the lower part of the first heat insulation member 40.

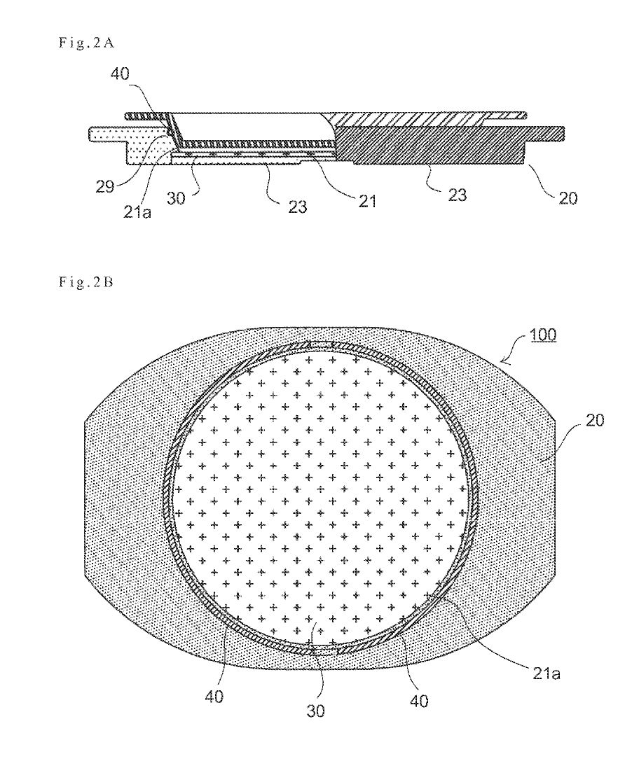

As another embodiment in which the first heat insulation member 40 is used for supporting, FIG. 2 shows a tray 100 and a tray set in which a groove 29 is formed around the top inner circumference of the recessed portion side wall 21a, to which the first heat insulation member 40 in an arcuate shape is fixedly installed. FIG. 2A is a sectional view and a side view of the tray set, and FIG. 2B is a plan view of the tray 100. As shown in FIG. 2A, the recessed portion 21 which can accommodate the plate 10 is formed in the tray main body 20. In the section view, the groove 29 in an arcuate shape is formed at the upper part of the recessed portion side wall 21a. The first heat insulation member 40 in an annular shape is fixedly installed to this groove 29. The diameter of the inner circumference of the first heat insulation member 40 is shorter than the diameter of the maximum outer perimeter of the plate 10 formed in the shape of a taper. If the plate 10 is accommodated in the recessed portion 21, the outer perimeter of the plate 10 is pressed by the heat insulation member 40 and supported at a predetermined position of the recessed portion. Incidentally, the first heat insulation member 40 is not limited to an annular shape, it may be divided into multiple member pieces and intermittently fixedly installed to the groove 29. According to a method in which the outer perimeter of the plate 10 is laterally pressed by the heat insulation member 40 which is fixedly installed to the recessed portion side wall 21a, as the first heat insulation member 40 does not exist between the bottom of the plate 10 and the second heat insulation member 30, the distance between the heater of the electromagnetic induction heating device and the plate 10 can be more shortened, the thickness of the tray main body 20 can be thinner and the weight can be reduced. As shown in FIG. 2, space is preferably formed between the plate 10 and the second heat insulation member 30. By this space, even when the plate 10 is heated, the space can prevent the heat from directly transferring to the second heat insulation member 30, and can prevent the heat deterioration of the second heat insulation member 30.

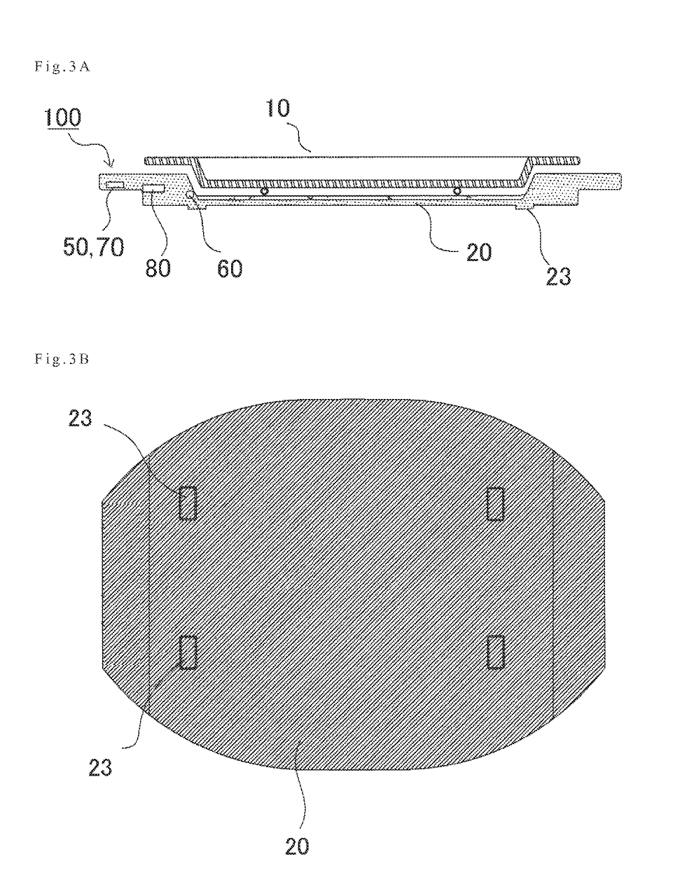

Temperature sensing means 60 for detecting the temperature and the alarm means 70 which alarms when the temperature detected by the temperature sensing means is equal to or more than a predetermined value or the like may be arranged at a part of the tray 100 of the present disclosure. If a temperature switch is used as the temperature sensing means 60 and the switch of the alarm means 70 is set to be turned on when the temperature of the tray 100 becomes equal to or more than the predetermined temperature, it can detect whether it can be safely hold the tray 100 or not without touching it, thereby preventing burn injury and excess heat at the time of cooking. Therefore, the tray 100 of the present disclosure excels in safety. Furthermore, stop means 80 may be arranged which can turn ON and OFF the power of the electromagnetic induction heating and cooking apparatus by the temperature sensing means 60. FIG. 3 shows an embodiment in which the temperature sensing means 60, the alarm means 70, and the stop means 80 are arranged in the electromagnetic induction heating plate set of FIG. 1. The reference no. 50 in FIG. 3 represents a power supply such as a battery arranged in the temperature sensing means 60 or the alarm means 70. In order to avoid the influence by electromagnetic induction, a cable arranged at a grip (not shown in the drawings) consecutively connects the temperature sensing means 60 and the alarm means 70.

As the plate 10 configuring the electromagnetic induction heating plate set of the present disclosure is composed of a material to be heated by electromagnetic induction, and does not request to arrange a heat storage member and the like in the tray 100, thereby reducing the weight of the tray 100. Even if heat from the plate 10 tends to be easily transferred to a grip due to thinned layers of the tray main body 20, heat transfer to the grip can be prevented by at least the first heat insulation member 40, and the heat is released through the feet 23. Thus, heat deterioration of the tray 100 can be efficiently prevented, and one can directly hold the tray 100 with heated cooking ingredients.

(2) Tray

The tray 100 of the present disclosure includes the tray main body 20 in which the recessed portion 21 for accommodating the plate 10 is formed or a through-hole forming a part of the recessed portion 21 is formed, and at least the first heat insulation member 40 for supporting the plate.

The shape of the recessed portion 21 accommodating the plate 10 can be appropriately selected depending on the shape of the plate 10 to be used. The preferred shape and size of the recessed portion 21 is such that space is formed between the recessed portion side wall 21a and the plate 10 after the plate 10 is accommodated. The recessed portion 21 may be a concave portion for accommodating the plate 10 or may be a through-hole in which the plate 10 can be invaginated and a hollow portion which is formed by covering an end of the through-hole with another member. Any member configuring the tray main body 20 and/or the second heat insulation member 30, can be used as the through-hole covering member.

The tray main body 20 may be configured with a single member or configured with multiple members. The tray main body 20 can be configured with materials, for example, such as wood, paper, ceramics, plastics, a complex thereof, or the like.

The first heat insulation member 40 is board-shaped, lineal, columnar and/or hollow-columnar, which is molded and made of carbon fibers, aramid fibers and/or rock fiber. A board-shaped is not limited to a flat plate and may be corrugated or the like. Shapes of a lineal, columnar and/or hollow-columnar member are not limited to a straight line but may be arcuate shape or the like. Any of these members excel in heat resistance, are not heated by electromagnetic induction, and excel in mechanical strength. As fixedly installing positions and/or methods are not specifically limited if intensity that can support the heated plate 10 can be secured.

It is desirable that the second heat insulation member 30 is arranged at the bottom of the recessed portion 21. Besides carbon fiber cloth, inorganic fibers such as an aramid fiber, a slag fiber, a glass fiber and a rock fiber, and a coating layer such as a heat-resistant paint in which inorganic particles such as silica powder are blended, can be used for the second heat insulation member 30. A carbon fiber, for example, such as a polyacrylonitrile (PAN) type, a pitch (isotropic pitch, anisotropic pitch) type, a phenol resin type, a rayon type, a cellulose type, and a polyvinyl alcohol (PVA) type, can be used. A single inorganic fiber or a combination of two or more types of inorganic fibers can be used. Among them, carbon fiber cloth or aramid fiber cloth, which is lightweight, excels in heat insulation, bending strength and shock resistance, and is easy to be processed, can preferably be used. The second heat insulation member 30 is desirably arranged at a position at which the plate 10 does not directly contact to the second heat insulation member 30. An intervention of the second heat insulation member 30 in such an embodiment maintains the temperature of the heated plate 10 and can inhibit heat transfer to the tray 100 by the space between the plate 10 and the second heat insulation member 30 within the recessed portion 21. In addition, as shown in FIG. 1, when the first heat insulation member 40 is fixedly installed to the bottom of the recessed portion 21, the second heat insulation member 30 and the first heat insulation member 40 are desirably fixedly installed not to contact to each other. This can effectively inhibit the heat deterioration of the second heat insulation member 30.

The tray 100 of the present disclosure can be manufactured in any manufacturing method as long as it can give the above-mentioned configuration. For example, the tray main body 20 may be configured using a single member in which the recessed portion 21 and the through-hole are formed. The tray main body 20 may be partitioned into three layers, the tray bottom 20a, the tray middle part 20b, and the tray top part 20c, which may be laminated for manufacturing the tray 100.

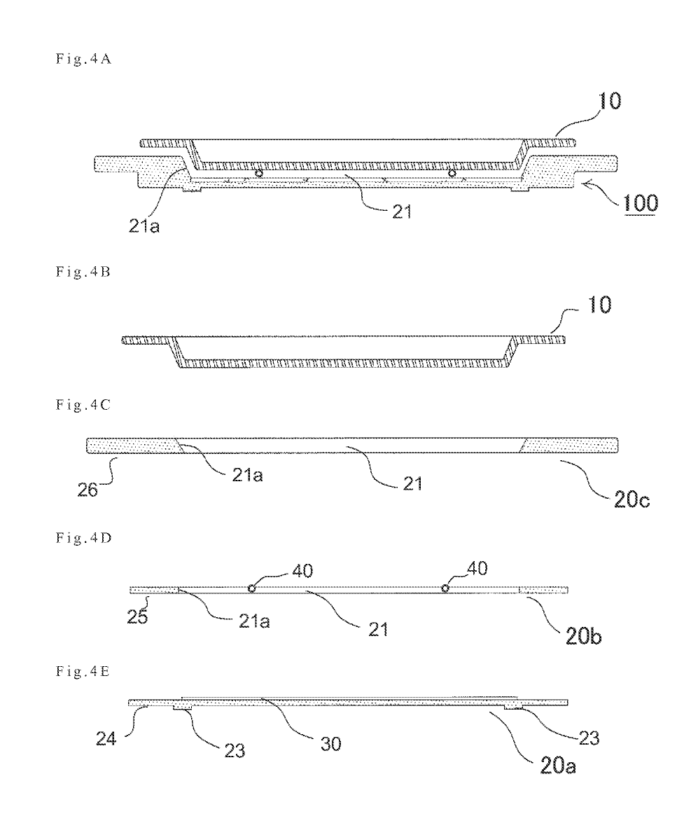

FIG. 4A shows a sectional view of the electromagnetic induction heating plate set which includes the tray 100 shown in FIG. 1 which is configured with three layers of the tray bottom 20a, the tray middle part 20b, and the tray top part 20c, and the plate 10 placed on the tray 100. FIG. 4B is a sectional view of the plate, FIG. 4C is a sectional view of the tray top part 20c made of a top part member 26 configuring a grip of the tray 100, FIG. 4D is a sectional view of the tray middle part 20b across which the first heat insulation member 40 is laid across a middle member 25 in a tensioned state, and FIG. 4E is a sectional view of the tray bottom 20a in which the second heat insulation member 30 is adhered to the bottom member 24. The tray 100 can be manufactured by laminating these and fixing the each layer by heat-resistant adhesives or the like. The tray 100 with the plate 10 placed thereon makes the electromagnetic induction heating plate set of the present disclosure shown in FIG. 4A.

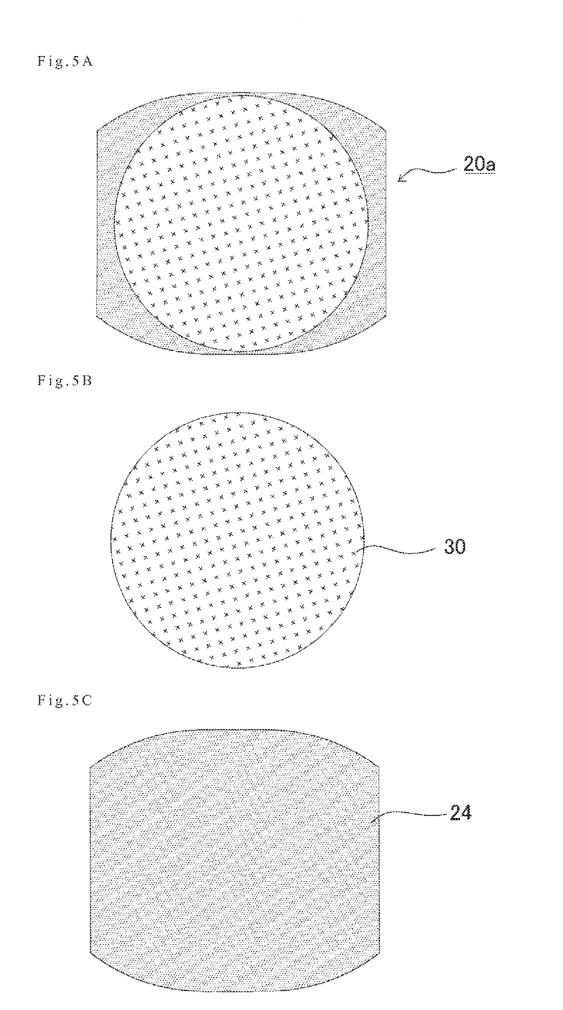

The configuration of the tray bottom 20a is shown in FIG. 5. FIG. 5A is a plan view of the tray bottom 20a, FIG. 5B is a plan view of the second heat insulation member 30, and FIG. 5C is a plan view of the tray bottom member 24. If the second heat insulation member 30 such as, for example, carbon fiber cloth is adhered to the tray bottom member 24 cut in a predetermined shape, a tray bottom 20a shown in FIG. 5A is provided. The tray bottom member 24 can be configured with wood, paper, ceramics, plastics, complexes thereof, or the like, and may be, for example, a sheet of plywood or the like. The second heat insulation member 30 is placed on the tray bottom member 24 to be the bottom of the recessed portion 21 and fixed with a heat-resistant adhesive or the like as necessary. In addition, although not illustrated, one or more through-hole having a diameter smaller than the second heat insulation member 30 may be formed at the installation position of the second heat insulation member 30 in the tray bottom member 24. The heat of the plate 10 can be dissipated from the upper part toward the bottom of the tray bottom member 24 through the through-hole, and overheating of the tray main body 20 can be prevented. In addition, the feet 23 (not shown) are formed at the back face of the tray bottom member 24.

The thickness of the tray bottom member 24 is 1.5-7.0 mm including the feet 23, and preferably is 2.0-5.0 mm. If the thickness exceeds 7.0 mm and the tray is placed on an electromagnetic induction heating and cooking apparatus, the distance between the heater of the electromagnetic induction heating and cooking apparatus and the plate 10 may become long, and the heating efficiency of the plate 10 by electromagnetic induction may be decreased.

The present disclosure is characterized by the feet 23 being arranged in the tray 100. In an electromagnetic induction heating and cooking apparatus, a high-frequency magnetic field is generated by flowing current of tens of kHz from a high-frequency inverter through a magnetic force generating coil, eddy current is induced at the bottom of a pan arranged on the upper part of the electromagnetic induction heating and cooking apparatus, and the pan itself is heated by this eddy current. As the pan itself is heated, heat losses such as heated air or radiant heat are small and the thermal efficiency is high. However, inside an inverter, semiconductor switching elements generate heat by repeated on's and offs, and the generated heat is transferred to a heater. As the pans for electromagnetic induction heating are generally heat-conductive, the heat is transferred to the pans. The pans are intended to be heated, no problem occurs at all. However, if the heat generated at the heater is transferred to the tray main body 20, the heat will be stored in the bottom of the tray 100. In order to dissipate the heat from the electromagnetic induction heating and cooking apparatus originating in the above-mentioned semiconductor switching elements and the like, in addition to the heat of the plate 10 having a high temperature heated by electromagnetic induction, the feet 23 are formed at the tray 100.

The height of the feet 23 is 0.5-3 mm, preferably 0.7-3 mm If the feet 23 are formed at the height of these ranges, the heat of the heated plate 10 can be dissipated efficiently from the space between the electromagnetic induction heating and cooking apparatus and the bottom of the tray 100, and the temperature rise in the tray 100 can be prevented. Thus, the weight of the tray 100 can be reduced due to thinned members and small heat transfer.

In addition, the thickness of the second heat insulation member 30 is 0.5-5 mm, preferably 1.0-3.0 mm. The heat transfer from the plate 10 can be sufficiently controlled in these ranges.

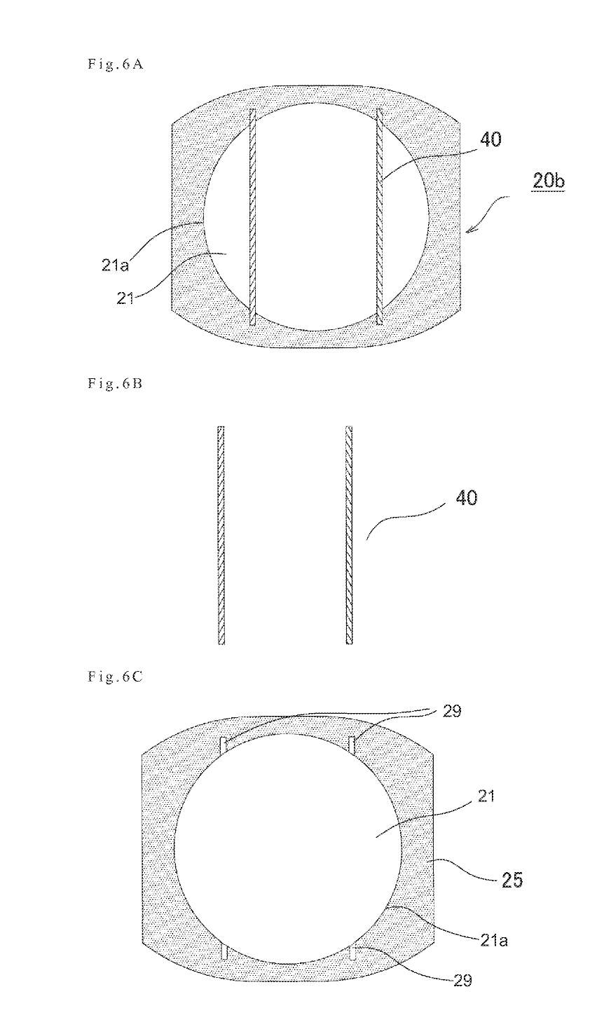

The configuration of the tray middle part 20b is shown in FIG. 6. FIG. 6A is a plan view of the tray middle part 20b, FIG. 6B is a plan view of the first heat insulation member 40, and FIG. 6C is a plan view of the tray middle member 25. As shown in FIG. 6C, a circular through-hole is formed in the center of the tray middle member 25 configuring a part of the recessed portion 21 of the tray main body 20. Moreover, four grooves 29 which fix the first heat insulation member 40 in a tensioned state are formed at four positions. The tray middle part 20b can be manufactured by laying across the first heat insulation member 40 in a tensioned state by fitting into the tray middle member 25 and by fixing the first heat insulation member 40 to the tray middle member 25 using a heat-resistant adhesive or the like, as necessary. The tray middle part 20b can be configured with wood, paper, ceramics, plastics, complexes thereof, or the like.

The thickness of the tray middle member 25 is 2.0-6.0 mm, and preferably is 2.5-5.0 mm If the thickness exceeds 6.0 mm, when the tray is placed on an electromagnetic induction heating and cooking apparatus, the distance between electromagnetic induction heating and cooking apparatus and the plate 10 may become long, and it is sometimes difficult to heat the plate 10 by electromagnetic induction. The length of a board-shaped, lineal, columnar and/or hollow-columnar heat insulation member made of carbon fibers and/or aramid fibers used as the first heat insulation member 40 may be a length which can be placed in the recessed portion 21.

The diameter of the first heat insulation member 40 is, for example, 1-5 mm, preferably 1.5-4.5 mm, calculated in terms of equivalent round, depending on the number arranged. If the diameter of the first heat insulation member 40 is within these ranges, the plate 10 having cooking ingredients accommodated can be stably placed on.

The first heat insulation member 40 is preferably arranged not to contact with the second heat insulation member 30, thereby, deterioration of the second heat insulation member 30 can be efficiently prevented, and eventually, the durability of the tray 100 can be improved. A gap between the second heat insulation member 30 and the first heat insulation member 40, when not in contact, can be controlled by adjusting the depth and the like of the groove 29 which fits into the first heat insulation member 40.

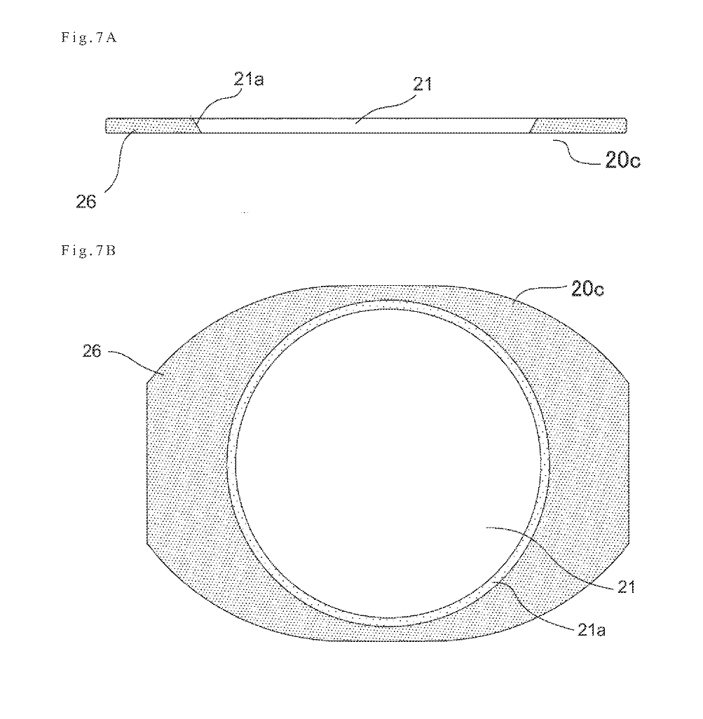

FIG. 7A shows a sectional view of the tray top part 20c configured with the top member 26, and FIG. 7B shows a plan view of tray top part 20c. The top member 26 is formed longer than the tray middle member 25 in the longitudinal direction such that the both ends of the tray 100 can be used as grips. The recessed portion 21 is formed in the approximate center, and the recessed portion side wall 21a forms a taper shape. The tray middle member 25 and the top member 26 require depth sufficient for stably placing the plate 10 accommodating cooking ingredients, stiffness sufficient for being capable of holding the placed tray 100 without deformation, and heat resistance that can inhibit the heat transfer from the heated plate 10. The tray middle member 25 and the top member 26 can be configured with materials, for example, such as wood, paper, ceramics, plastics, complexes thereof, and/or the like. The thicknesses of the tray middle member 25 and the top member 26 generally is 3-40 mm, preferably 5-30 mm depending on the thicknesses of other members.

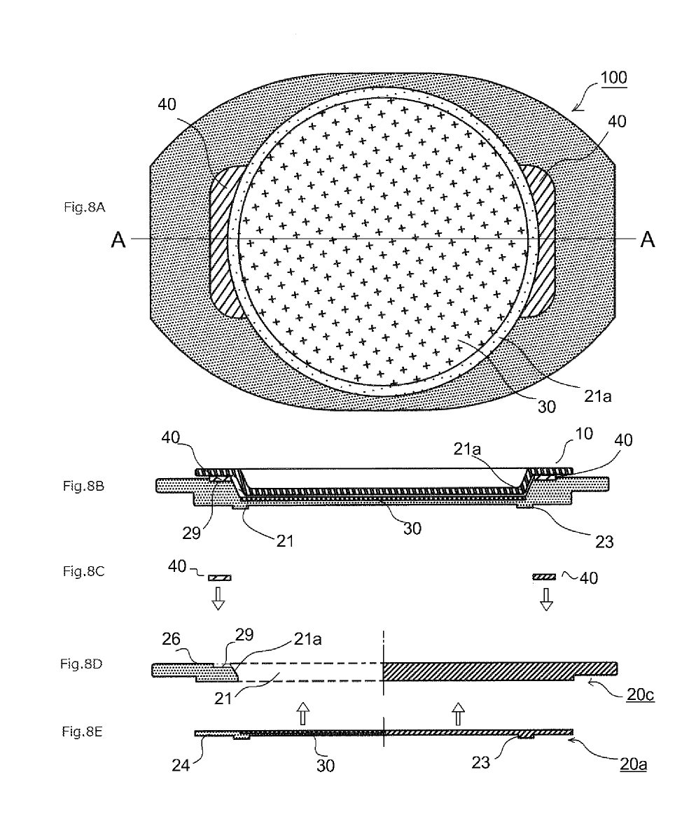

The above mentioned is a method for manufacturing the tray 100 in which a groove 29 is formed in the tray middle member 25, and two of the first heat insulation members 40 are fixedly installed in parallel. However, as shown in FIG. 8 as the tray 100, the groove 29 may be formed in the upper surface of the top member 26, to which a board-shaped first heat insulation member 40 may be adhered. FIG. 8A is a plan view of such a tray. FIG. 8B is an A-A line sectional view of FIG. 8A, FIG. 8C is a sectional view and a side view of the first heat insulation member 40, FIG. 8D is a sectional view and a side view of the tray top part 20c, and FIG. 8E is a sectional view and a side view of the tray bottom 20a to which the second insulation member 30 configuring the tray is adhered. The through-hole configuring a part of the recessed portion 21 is formed in the top member 26 configuring the tray top part 20c, and the grips are formed on both ends in the longitudinal direction. Moreover, the grooves 29 for fitting a pair of first heat insulation members 40 are formed around the outer perimeter of the through-hole. In order to manufacture such a tray 100, for example, the tray top part 20c, and the tray bottom 20a which the second heat insulation member 30 is adhered to the tray bottom member 24 beforehand may be laminated, and then the first heat insulation member 40 may be fixedly installed to the groove 29 in the tray top part 20c. In this embodiment, different from FIG. 4, the tray middle part 20b is unnecessary. The first heat insulation member 40 fixedly installed to the tray top part 26 can support the flange part of the plate 10 from a lower side, and can prevent the recessed portion 21 from contacting to the plate 10. Incidentally, the first heat insulation member 40 is preferably fixedly installed to the tray 100 such that the accommodated plate 10 can be supported without direct contacting with the second heat insulation member 30. The space between the plate 10 and the second heat insulation member 30 can be secured by adjusting the height of the tray top part 20c, the thickness of the first heat insulation member 40 and the like.

The above shows an embodiment in which, when the tray main body 20 includes a plurality of layers, each layer is fixed via heat-resistant adhesives. When the layers are configured with heat-resistant plastics or the like, each layer may be integrated by thermal welding using the plastics configuring the each layer, or fixed by fasteners or the like.

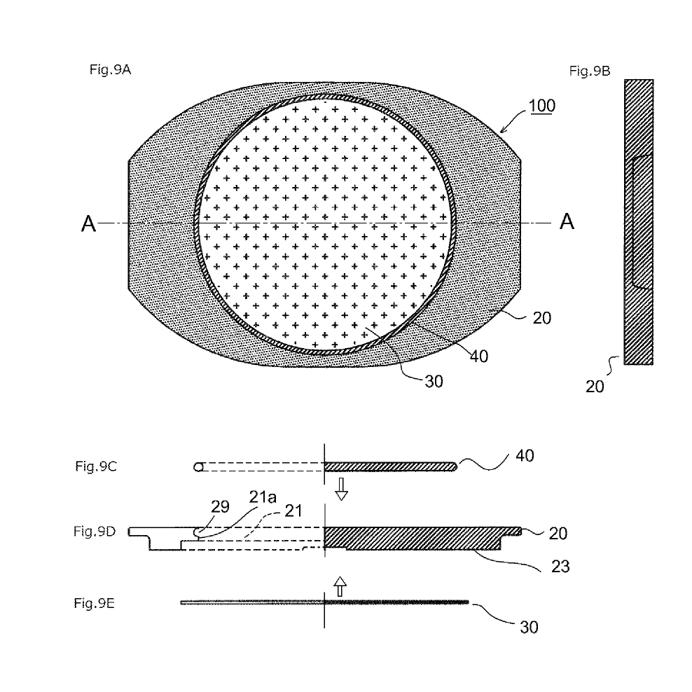

Furthermore, the tray of the present disclosure may be a tray what the first heat insulation member 40 is fixedly installed to a main body 20 prepared as an integrated object. For example, FIG. 9 describes an example where the tray 100 shown in FIG. 2 is manufactured. FIG. 9A is a plan view of the tray 100, FIG. 9B is a side view, FIG. 9C is an A-A line sectional view and a side view of the first heat insulation member 40, FIG. 9D is an A-A line sectional view and a side view of the tray main body 20, and FIG. 9E of an A-A line sectional view and a side view of the second heat insulation member 30. As shown in FIG. 9D, the through-hole configuring a part of recessed portion 21 is formed in the tray main body 20. The cross-sectionally viewed circular groove 29 is formed at the top inner circumference of the recessed portion side wall 21a. The board-shaped second heat insulation member 30 is inserted into the tray main body 20 to cover the through-hole from the bottom side to be the bottom of the recessed portion 21. The first heat insulation member 40 bent in an arcuate shape from the top side is inserted to fit into and adhere to the groove 29. As the tray main body 20 is configured with an integrated object, the tray 100 can be manufactured simply by arranging the first heat insulation member 40 and the second heat insulation member 30 at the tray main body 20.

(3) Alarm Means

When the tray 100 is used, alarm means 70, that senses the temperature of the tray 100 and when the temperature is equal to or more than a predetermined value, the alarm means gives an alarm, can be arranged in the tray 100 of the present disclosure. The alarm may be an light alarm such as blinking light or the like besides a sound alarm such as buzzer sound or the like, or both sound and light. For example, the temperature sensing means 60 can be a temperature switch that turns on when the temperature reaches the predetermined temperature. The alarm means 70 can be a buzzer, a light, or the like controlled by this temperature switch. As shown in the FIG. 3, the temperature sensing means 60 is suitably arranged in the vicinity of the bottom of the recessed portion side wall 21a of the tray 100. As the heated plate 10 is accommodated inside the recessed portion 21, the recessed portion side wall 21a tends to be easily affected by the heat transfer from the plate 10. Moreover, the bottom of the tray 100 receives the dissipated heat from the semiconductor switching elements of the electromagnetic induction heating and cooking apparatus. Therefore, the vicinity of the bottom of the recessed portion side wall 21a of the tray 100 is the hottest part when in use. Therefore, based on the temperature, it is detectable whether the tray can be held or not without direct contacting with the tray 100. Thus, the tray is superior in safety. FIG. 3 shows an embodiment in which the temperature sensing means 60 is arranged in the vicinity of the bottom of the recessed portion side wall 21a of the tray 100. Incidentally, the temperature sensing means 60 can be arranged at the grip, the top part, or the like of a tray. In addition, the power supply 50 and the alarm means 70, such as a buzzer or an LED light, are arranged at the grip, the top part, or the like of a tray 100 which is not heated by electromagnetic induction.

(4) Stop Means

In the present disclosure, in addition to the alarm means 70, stop means 80 may be arranged which stops the electromagnetic induction of the electromagnetic induction heating and cooking apparatus to be used when the temperature of the tray 100 is equal to or more than the predetermined value.

Generally, a control circuit configured mainly with a microcomputer is arranged in an electromagnetic induction heating and cooking apparatus. The control circuit detects the material of the pan in use and the heating temperature is controlled based on the detected information. A heating coil is arranged under the heater of the electromagnetic induction heating and cooking apparatus. Temperature sensors such as a thermistor, are installed in the vicinity of the coil. The information of the thermistor is inputted into the control circuit, and an oscillation operation (transistor's ON and OFF operations) and an oscillation stop (continuous OFFs of a transistor) of a high-frequency inverter are outputted so that the temperature of the heater sensed by the thermistor becomes a predetermined temperature. Therefore, the ON-OFF information of the temperature sensor of the temperature sensing means 60 is inputted into the control circuit of the electromagnetic induction heating and cooking apparatus, and can be controlled to stop the oscillation of a high-frequency inverter via the control circuit of the electromagnetic induction heating and cooking apparatus. Moreover, inputting the information of the temperature sensing means 60 of the tray 100 into the control circuit of the electromagnetic induction heating and cooking apparatus can be performed via a low power wireless module which, for example, can be driven by a battery and which can receive and transmit via the spread spectrum system. Because low power wireless communication consumes small power and does not need to obtain a license for a radio station. Signal receiving means from a low power wireless module is arranged in the electromagnetic induction heating and cooking apparatus. The received signal is inputted into the control circuit as temperature information of the tray 100, and allows the control circuit to control in conjunction with the ON-OFF of the temperature sensing means 60. When the temperature of the tray 100 exceeds the predetermined temperature, heating of the electromagnetic induction heating and cooking apparatus can be stopped by this stop means. Such a low power wireless module can be arranged in the vicinity of the power source 50 at the bottom of the tray 100, for example, shown in the FIG. 3A. Incidentally, the above is described in an embodiment in which the temperature sensing means 60 and a low power wireless module are arranged together. However, the temperature sensing means 60 may be controlled to operate the alarm means 70 and at the same time controlled to stop the oscillation of a high-frequency inverter via the control circuit of the electromagnetic induction heating and cooking apparatus.

(5) Plate

When the tray 100 is used, the plate 10 which can be used by being placed on the tray 100 includes a member adapted to be heated by electromagnetic induction. As the heat storage member and the like are not used for the tray 100, unless plate 10 is heated by electromagnetic induction, cooking ingredients cannot be heated by electromagnetic induction. For example, members having magnetism, such as iron, enameled iron, iron casting, ferrite series stainless steel, and multilayered steel are examples of the plate 10. Moreover, when using the electromagnetic induction heating and cooking apparatus which can heat a nonmagnetic material, the plate 10 including a material which can be heated with such an apparatus can be used. A plate including aluminum, copper, aluminum layered, or copper layered member is an example. Such a material may not only be a material that can be heated by electromagnetic induction, but also a material that emits far-infrared rays, for example.

(6) Usage

Cooking is performed by the electromagnetic induction heating and cooking apparatus using the electromagnetic induction heating plate set of the present disclosure by the following method. First, the plate 10 is accommodated in the tray 100 and placed on the heater of the electromagnetic induction heating and cooking apparatus. Cooking ingredients may be put on the plate 10 beforehand. The plate 10 is heated by electromagnetic induction, and cooking ingredients are heated and cooked on the heated plate 10. After the cooking ingredients are heated and cooked, the whole tray 100 can be used on a table as tableware. The tray 100 of the present disclosure can be widely used for a steak, roast meat, gratin, spaghetti, and the other foods edible by heating.

The present disclosure is based on the Japan patent application No. 2012-069755 filed on Mar. 26, 2012. The specification, the claims, and the drawings of the Japan patent application No. 2012-069755 are incorporated into the present disclosure by reference.

### INDUSTRIAL APPLICABILITY

The present disclosure excels in durability and heat insulation and is useful. The present disclosure provides a lightweight electromagnetic induction heating and cooking tray and an electromagnetic induction heating plate set.

### REFERENCE SIGNS LIST

10 Plate
20 Tray main body
21 Recessed portion
21a Recessed portion side wall
23 Feet
24 Tray bottom member
25 Tray middle member
26 26 Tray top part member
29 Groove
30 Second heat insulation member
40 First heat insulation member
50 Power supply
60 Temperature sensing means
70 Alarm means
80 Stop means
100 Tray

1. An electromagnetic induction heating and cooking tray being formed a recessed portion for accommodating an electromagnetic induction heating and cooking plate, which comprises:
a tray main body being formed the recessed portion or a through hole configuring a portion of the recessed portion,
a board-shaped, lineal, columnar and/or hollow-columnar first heat insulation member being molded and made of carbon fibers, aramid fibers and/or rock fiber, for supporting the plate; and
feet being protruded from the bottom of the tray main body.

2. The electromagnetic induction heating and cooking tray according to claim 1, wherein one or more types of second heat insulation member selected from the group consisting of carbon fibers, aramid fibers and rock fibers, is arranged at the bottom of the recessed portion.

3. The electromagnetic induction heating and cooking tray according to claim 2, wherein the tray main body is formed the through hole configuring a portion of the recessed portion, and wherein the second heat insulation member is attached to the through hole to form the bottom of the recessed portion.

4. The electromagnetic induction heating and cooking tray according to any of claims 1-3, wherein temperature sensing means for detecting the temperature of the tray and/or alarm means that alarms when the temperature of the tray is equal to or more than a predetermined value is further arranged.

5. An electromagnetic induction heating plate set comprising
the electromagnetic induction heating and cooking tray according to any of claims 1-4: and
an heating and cooking plate heated by electromagnetic induction.
